(19) United States
(12) Patent Application Publication
(10) Pub. No.: US 2014/0113545 A1
(43) Pub. Date: Apr. 24, 2014

(54) WIRELESS RELAYING METHOD, METHOD OF CONTROLLING RELAY MODE, AND WIRELESS RELAY APPARATUS

(71) Applicant: Electronics and Telecommunications Research Institute, Daejeon (KR)

(72) Inventors: Jae Sheung SHIN, Daejeon (KR); Sook Yang KANG, Daejeon (KR); Eun Ah KIM, Daejeon (KR); Hyun Seo PARK, Daejeon (KR); Sung Min OH, Daejeon (KR); Ae Soon PARK, Daejeon (KR)

(73) Assignee: Electronics and Telecommunications Research Institute, Daejeon (KR)

(21) Appl. No.: 14/057,302

(22) Filed: Oct. 18, 2013

(30) Foreign Application Priority Data
Oct. 19, 2012 (KR) 10-2012-0116409

(51) Int. Cl. H04B 7/14

(52) U.S. Cl. CPC H04B 7/14
USPC 455/7

(57) ABSTRACT

Provided are a wireless relaying method, a method of controlling a relay mode, and a wireless relay apparatus using the wireless relaying method. The wireless relaying method of a relay node (RN) includes operating in an amplify-and-forward (AF) mode of amplifying and forwarding a received signal upon setup, broadcasting identifier (ID) information on the RN, and, when a mode change message is received from an evolved node-B (eNB), changing an operating mode to a decode-and-forward (DF) mode. Accordingly, it is possible to improve resource efficiency while having an advantage of minimum delay time for relay.

### CLAIM FOR PRIORITY

This application claims priority to Korean Patent Application No. 2012-0116409 filed on Oct. 19, 2012 in the Korean Intellectual Property Office (KIPO), the entire contents of which are hereby incorporated by reference.

### BACKGROUND

1. Technical Field

Example embodiments of the present invention relate in general to a relaying method, and more particularly, to a wireless relaying method and a method of controlling a relay mode in a multi-hop mobile communication system including a wireless relay node (RN) having multiple relay modes, and a wireless relay apparatus using the wireless relaying method.

2. Related Art

An RN is a device serving as an intermediary between an evolved node-B (eNB) and user equipment (UE), and is mainly installed at a shade region or a cell boundary to effectively extend cell coverage and increase throughput without adding a new eNB or additionally establishing a wired backhaul.

An RN may be installed at the cell coverage boundary of a donor eNB or outside the cell coverage boundary to provide service to UE located outside the cell radius of the eNB or to relay a signal of the eNB to UE located across a cluster of buildings from the eNB, among buildings, in a building having a poor wireless environment, and in a subway train. FIG. 1 shows an RN use model in which an RN is used to improve cell throughput. RNs 200-1 and 200-2 shown in FIG. 1 are located within the cell radius of a donor eNB 100, and provide better quality service to pieces of UE located close to a cell boundary compared to a case in which there is no RN. In other words, in the case of a first piece of UE 300-1 in which there is no RN between the eNB 100 and the first piece of UE 300-1, a low transmission rate, for example, a quadrature phase-shift keying (QPSK) link, is provided to the first piece of UE 300-1. On the other hand, in the cases of a second piece of UE 300-2 and a third piece of UE 300-3 located within the cell radiuses of the RNs 200-1 and 200-2, the RNs 200-1 and 200-2 transmit data received from the eNB 100 to the second piece of UE 300-2 and the third piece of UE 300-3 at a high transmission rate, such as 64 quadrature amplitude modulation (QAM), so that cell throughput can be improved.

As described above, since a relay transmission method employing an RN extends an overall signal transmission distance that is limited by signal attenuation, and increases overall channel capacity, active research is underway.

As a typical relaying method, there is an amplify-and-forward (AF) method and a decode-and-forward (DF) method. The AF method has a high probability that an error will occur by amplification of noise, and the DF method has a drawback of long transmission delay. These drawbacks become obvious in a multi-hop system in which two or more RNs perform relay between an eNB and UE.

There is a necessity of an effective method for solving such a problem caused when only one of the two typical relaying methods of RNs is selected and used.

### SUMMARY

Accordingly, example embodiments of the present invention are provided to substantially obviate one or more problems due to limitations and disadvantages of the related art.

Example embodiments of the present invention provide a wireless relaying method.

Example embodiments of the present invention also provide a relay apparatus using the wireless relaying method.

Example embodiments of the present invention also provide a method of controlling a relay mode for the relay apparatus.

In some example embodiments, a wireless relaying method of a relay node (RN) which relays a signal between an evolved node-B (eNB) and user equipment (UE) includes:

operating in an amplify-and-forward (AF) mode of amplifying and forwarding a received signal upon setup; broadcasting identifier (ID) information on the RN; and when a mode change message is received from the eNB, changing an operating mode to a decode-and-forward (DF) mode.

The wireless relaying method may further include, when a random access message is received from at least one piece of UE in the DF mode, generating and transmitting a random access response message to the UE.

The mode change message may include random access information transmitted from UE to the eNB, and the random access message may include an ID of the RN.

The wireless relaying method may further include, when a last piece of UE having been attached to the RN is detached, changing the operating mode of the RN to the AF mode.

In other example embodiments, a method of controlling a mode of an RN in an eNB which communicates with at least one RN includes: receiving a random access signal including an ID of the RN from a piece of UE; identifying the RN through the ID of the RN; and transmitting a mode change request to the identified RN.

The method may further include: receiving a report that all pieces of UE have been detached from the RN; and transmitting a mode change notification to the RN.

In other example embodiments, a wireless relay apparatus which wirelessly relays data between an eNB and UE includes: a receiver configured to receive signals from the eNB and the UE, and perform a receiving process on the received signals according to an operating mode; a transmitter configured to perform a transmitting process on signals to be transmitted to the eNB and the UE according to the operating mode; and a controller configured to operate in an AF mode of amplifying and forwarding the signals received by the receiver upon setup, broadcast ID information on an Relay Node (RN), and change the operating mode to a DF mode and control the receiver and the transmitter to operate according to the changed operating mode when a mode change message is received from the eNB.

When a random access message is received from at least one piece of UE in the DF mode, the controller may generate and transfer a random access response message to the transmitter.

When a last piece of UE having been attached to the RN is detached, the controller may change the operating mode to the AF mode.

The controller may perform resource allocation to the at least one attached piece of UE by reusing resources used by the eNB.

### BRIEF DESCRIPTION OF DRAWINGS

Example embodiments of the present invention will become more apparent by describing in detail example embodiments of the present invention with reference to the accompanying drawings, in which:

FIG. 1 shows a relay node (RN) use model in which an RN is used to improve cell throughput;

FIG. 2 is a conceptual diagram of operation according to an amplify-and-forward (AF) method;

FIG. 3 is a conceptual diagram of operation according to a decode-and-forward (DF) method;

FIG. 4 is a signal flowchart illustrating a case of using the AF relaying method in a multi-hop mobile communication system;

FIG. 5 is a signal flowchart illustrating a case of using the DF relaying method in a multi-hop mobile communication system;

FIG. 6 is a flowchart illustrating initial operation of RNs that operate according to a relaying method of the present invention;

FIG. 7 illustrates an example embodiment of the mode change operation flow of an RN that operates according to a relaying method of the present invention;

FIG. 8 illustrates an example embodiment of the operation flow of an RN that operates according to a relaying method of the present invention;

FIG. 9 illustrates another example embodiment of the mode change operation flow of an RN that operates according to a relaying method of the present invention; and

FIG. 10 is a block diagram of an RN according to an example embodiment of the present invention.

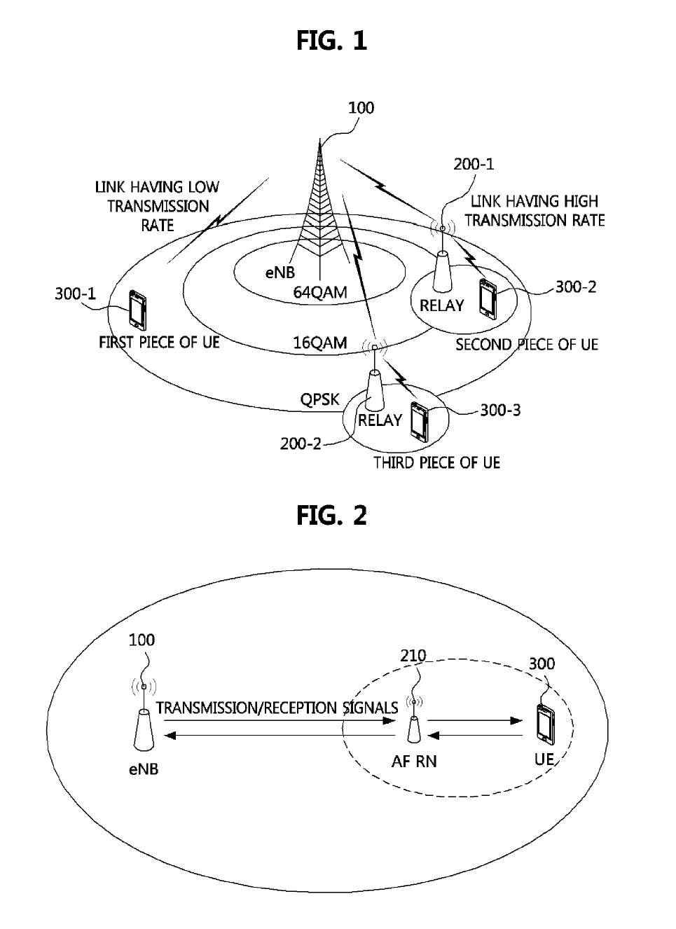

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “user equipment (UE)” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), mobile node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or UE having a combination of such functions, but are not limited to these.

The term “evolved node-B (eNB)” used herein generally denotes a fixed or moving point that communicates with a terminal, and may be a common name for base station, Node-B, base transceiver system (BTS), access point, and so on.

The term “relay node (RN)” used herein has a comprehensive meaning of an apparatus that relays communication between UE and an eNB. Also, an RN may be referred to as other terms such as relay, relay station (RS), and relay apparatus.

Hereinafter, example embodiments of the present invention will be described in detail with reference to the appended drawings. To aid in understanding the present invention, like numbers refer to like elements throughout the description of the figures, and the description of the same component will not be reiterated.

First, an amplify-and-forward (AF) method and a decode-and-forward (DF) method each will be described to aid in understanding a relaying method according to the present invention.

FIG. 2 is a conceptual diagram of operation according to the AF method.

According to whether or not an RN recovers a signal relayed by an RN, relaying methods of an RN are classified into the AF method and the DF method.

In the DF method, an RN recovers, that is, completely decodes, a received signal, compresses again, that is, encodes, the recovered signal, and then forwards the compressed signal.

On the other hand, in the AF method, an RN simply performs a linear process on a received signal without recovering the received signal, amplifies the processed signal, and then transmits the amplified signal.

The AF method in which radio frequency (RF) power is simply amplified and forwarded to UE as mentioned above has advantages in that it is relatively simple to implement and has short delay, but a drawback in that noise is also amplified together with a signal.

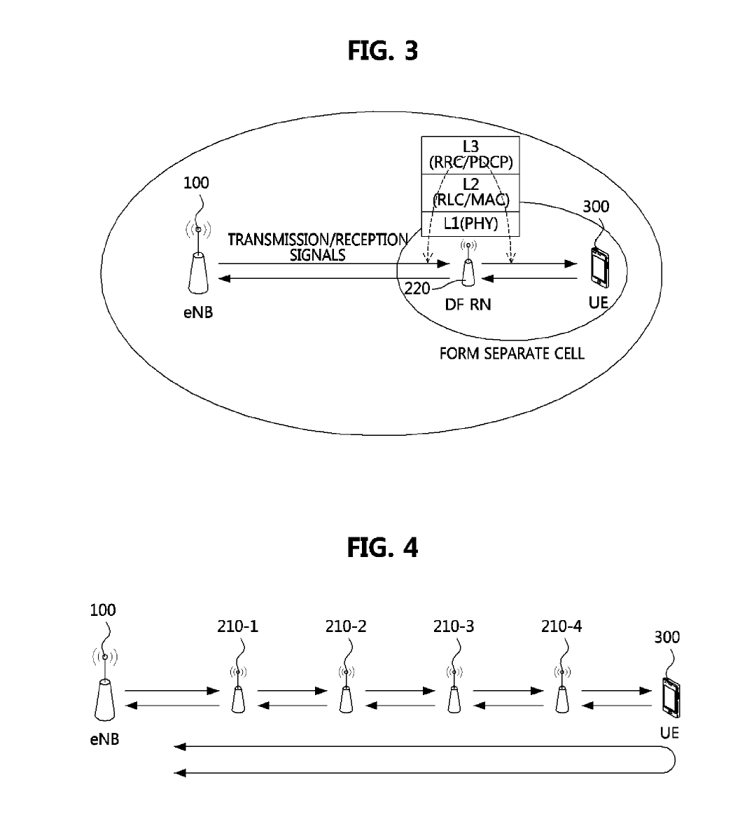

FIG. 3 is a conceptual diagram of operation according to the DF method.

In the AF method, a received signal is simply subjected to a linear process and then relayed. Thus, an RN is quite dependent on functions of an eNB, and cannot independently perform eNB functions, such as forming of a separate cell and resource allocation.

However, an RN that performs a DF function as illustrated in FIG. 3, forms a separate cell, and may be classified as a layer 1 (L1)/layer 2 (L2)/layer 3 (L3) RN according to a layer of a signal to be recovered. Currently, a wireless RN of Third Generation Partnership Project (3GPP) is based on an L3 RN of the DF method.

L1 includes a physical (PHY) layer function, L2 includes media access control (MAC) and radio link control (RLC) functions, and L3 includes radio resource control (RRC) and packet data convergence protocol (PDCP) functions.

For example, when a mobile communication system to which the present invention can be applied is a Long Term Evolution (LTE) system, the PHY layer handles coding/decoding, modulation/demodulation, multi-antenna mapping, and other general PHY layer functions. The PHY layer provides service to the MAC layer in the form of a transport channel.

The MAC layer handles hybrid automatic repeat request (HARQ) retransmission and uplink and downlink scheduling. A scheduling function is prepared in an eNB, and an eNB has one MAC entity per cell for an uplink and a downlink. An HARQ protocol portion is present on both a transmission end and a receiving end of an MAC protocol. The MAC layer provides service to RLC in the form of a logical channel.

RLC handles segmentation/concatenation, retransmission management, and sequential data transmission to an upper layer. In an LTE radio access network architecture, an RLC protocol is also located in an eNB. RLC provides service to a PDCP in the form of a radio bearer. There is one RLC entity per each of radio bearers configured for UE.

A PDCP performs Internet protocol (IP) header compression to reduce the number of bits transmitted over a radio interface. Also, a PDCP handles encryption and integrity protection of data to be transmitted. At a receiving end, a PDCP performs the corresponding decryption and decompression processes. There is one PDCP entity per each of system architecture evolution (SAE) bearers configured for UE.

An RRC layer handles radio bearer setup between an eNB and UE and configuration of all lower layers using RRC signaling, thereby playing the core role of an access network.

An L3 RN has independent UE attachment and resource allocation functions. Also, by reallocating (reusing) resources used by an eNB to UE that has been attached to an L3 RN as long as the influence of interference is minimized, it is possible to improve resource use efficiency of a whole system.

The DF method shows excellent link reliability, but has drawbacks of high complexity and increased frame delay.

In a multi-hop wireless relay system in which data is passed through several such RNs from an eNB to UE, merits/demerits are obviously shown according to methods used by the respective RNs.

FIG. 4 is a signal flowchart illustrating a case of using the AF relaying method in a multi-hop mobile communication system.

As shown in FIG. 4, when an AF multi-hop relaying method is used, delay time taken in each RN is short, and as a result, transmission delay from an eNB to UE is relatively short.

On the other hand, since a signal is delivered along a long transmission path from the eNB to the UE, and noise is amplified as well, the probability of an error increases. Also, when an error occurs, it is necessary for the eNB to start retransmission, and thus occurrence of an error has a strong influence on performance.

From the viewpoint of an eNB, the complexity and load of the eNB increase due to centralized resource management and retransmission control caused by an error. From the viewpoint of UE, the probability of an error increases due to transmission over a relatively long path between the UE and an eNB, and when an error occurs, performance deteriorates due to a long retransmission section. Such performance deterioration occurs on the eNB side as well.

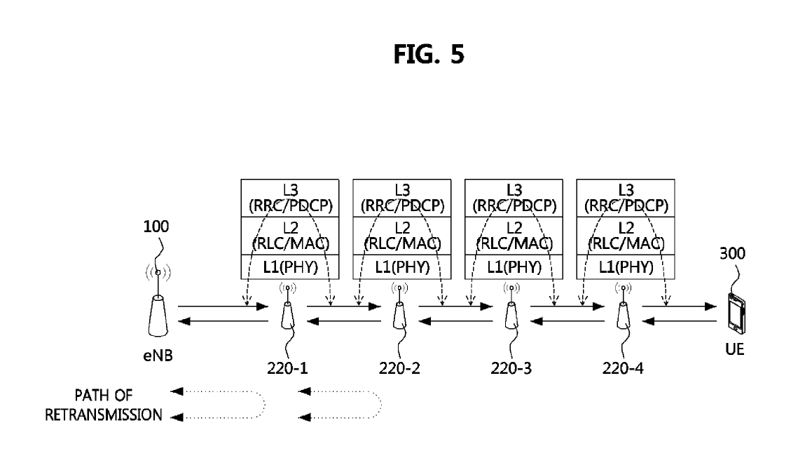

FIG. 5 is a signal flowchart illustrating a case of using the DF relaying method in a multi-hop mobile communication system.

In the case of a DF multi-hop relaying method illustrated in FIG. 5, each RN recovers a signal and retransmits the recovered signal, so that the probability of an error from an eNB to UE is reduced. In other words, a signal received by each RN is processed through L1, L3 and L3, subjected to a process necessary for transmission, and then transmitted to a next destination.

Due to such a procedure, even when an error occurs in each relay section, a signal is retransmitted in the corresponding section only. Thus, occurrence of an error has a small influence on overall performance. In particular, resources can be reused in each section as long as the influence of interference is minimized, and thus it is possible to improve resource efficiency. However, since data is recovered up to an upper layer and relayed at all times, there is a drawback of long transmission delay resulting from relay.

In other words, the DF method has advantages in that an error rate caused by signal recovery and transmission is reduced, and the load of retransmission is reduced due to a short retransmission section, but also has a drawback in that transmission delay time from an eNB to UE is long.

As described above with reference to FIG. 4 and FIG. 5, in a multi-hop wireless relay system, each RN is on a transmission path to an eNB, and thus it is the most important factor in improving performance to provide a high-speed data relay function, such as the AF method, that shows minimum delay. In addition, another important factor in improving the performance of a whole cell is to improve resource efficiency and reduce the load of an eNB by allocating/reusing optimum resources for each piece of UE, such as the DF method.

In consideration of merits and demerits of the AF and DF relaying methods described above, the present invention provides a relaying method for improving resource efficiency and reducing the influence of errors exerted on performance, which are merits of the DF relaying method, while having minimum delay time for relay, which is a merit of the AF relaying method.

A relaying method according to the present invention is on the assumption that a multi-mode RN supporting both the AF and DF methods is used.

An RN according to the present invention can change a relay mode to an AF or DF mode independently or by an external control such as operation and management (OAM).

Each RN according to the present invention does not only change a relay mode to the AF or DF mode, but also broadcasts unique identifier (ID) information so that UE approaching the service area of the RN can receive the unique ID information.

In an initial stage of a relaying method according to an example embodiment of the present invention, each RN is basically operated in the AM method for rapid data delivery with the minimum delay. After that, when an arbitrary piece of UE is attached to the RN, the corresponding RN is switched to the DF method so that the RN can independently allocate optimum resources to the UE by reusing resources used by an eNB.

Subsequently, when there is no UE attached to the RN due to movement of the UE, the RN is switched back to the AM method, thereby precisely performing a wireless backhaul relay function in need of high-speed data transmission.

Details of a relaying method of the present invention will be described below.

An RN according to the present invention is wirelessly connected to an eNB in a cell.

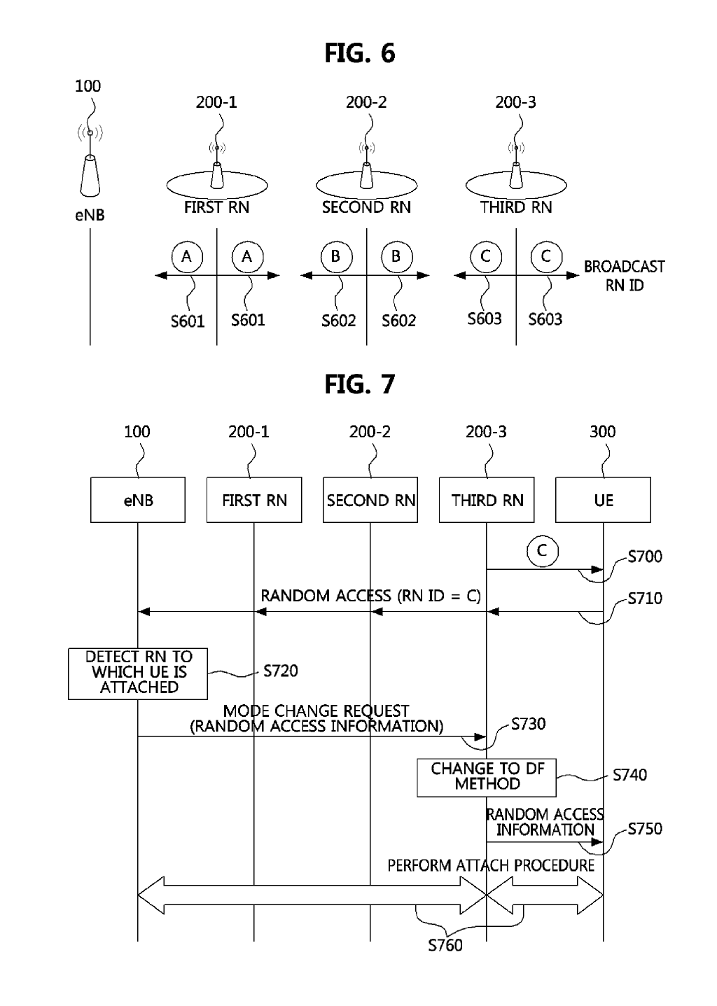

FIG. 6 is a flowchart illustrating initial operation of RNs that operate according to a relaying method of the present invention.

As shown in FIG. 6, in an initial stage, all RNs operate in the AF method to provide a rapid data delivery function with minimum delay. Also, all RNs broadcast unique ID information so that UE approaching the service areas of the RNs can receive the unique ID information.

For example, as shown in FIG. 6, a first RN 200-1 broadcasts its own ID “A” (S601), a second RN 200-2 broadcasts its own ID “B” (S602), and a third RN 200-3 broadcasts its own ID “C” (S603).

FIG. 7 illustrates an example embodiment of the mode change operation flow of an RN that operates according to a relaying method of the present invention.

When UE 300 enters the area of an arbitrary RN (a third RN 200-3 in FIG. 7), the UE 300 may receive ID information broadcast by the RN (S700). The UE 300 attaches the received ID information (“C” in FIG. 7) to a signal message for accessing a network, and transmits the signal message to an eNB 100 (S710). Here, a random access message may be an example embodiment of the signal message for the UE to access a network.

The eNB 100 having received the signal message for accessing a network detects the RN (the third RN 200-3) on the basis of the RN ID information (S720), and delivers a mode change request message to the RN so that the RN can permit an attachment of UE and independently allocate resources (S730). The mode change request message may be directly delivered from the eNB 100, or a function such as OAM may be used. Here, the mode change request message includes information on the random access signal that has been transmitted from the UE 300 to the eNB 100.

The RN (the third RN 200-3 in FIG. 7) having received the mode change message from the eNB 100 changes a mode to the DF method (S740), and transmits random access information for an attachment of UE to the UE 300 (S750). Subsequently, an attach procedure for the UE 300 to access a network is performed (S760).

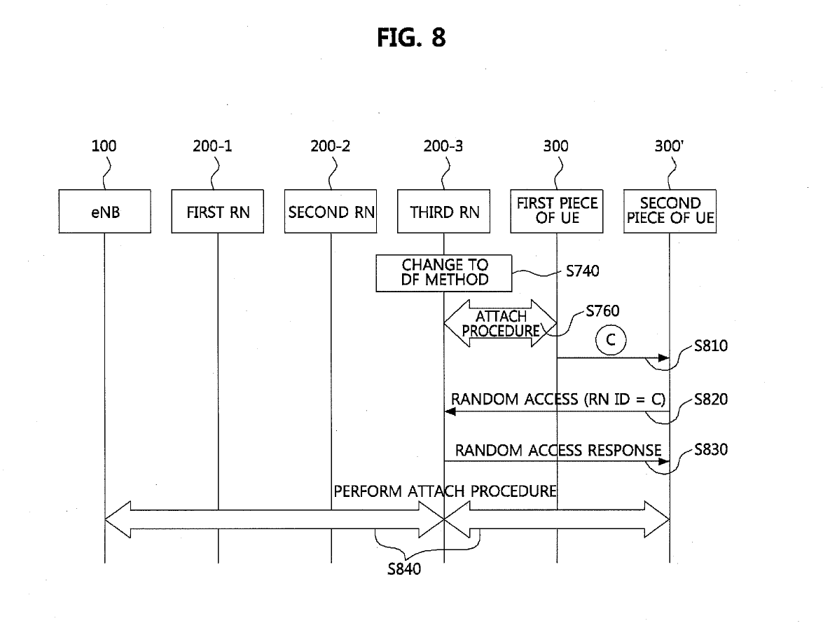

FIG. 8 illustrates another example embodiment of the mode change operation flow of an RN that operates according to a relaying method of the present invention.

FIG. 8 illustrates operation of an RN (a third RN 200-3) and UE (a second piece of UE 300′) when the UE is additionally attached to the RN having already been operating in the DF mode.

For example, in FIG. 8, the third RN that has already been switched to the DF method (S740) and operates, provides a relay function in the DF method without a mode change.

More specifically, when the second piece of UE 300′ enters the area of the third RN 200-3, the second piece of UE 300′ receives ID information broadcast by the third RN 200-3 (S810). The second piece of UE 300′ attaches the received ID information (“C” in FIG. 8) on the third RN 200-3 to a signal message for accessing a network, and transmits the signal message to the third RN 200-3 (S820). Likewise, a random access message may be an example embodiment of the signal message for accessing a network.

In FIG. 8, the random access message transmitted from the second piece of UE 300′ is received by the third RN 200-3 that forms a separate cell, and the third RN 200-3 transmits a random access response message to the second piece of UE 300′ in response to the random access of the second piece of UE 300′ (S830). Subsequently, an attach procedure for UE to access a network is performed between the third RN 200-3 and the second piece of UE 300′, and between the third RN 200-3 and the donor eNB 100 (S840).

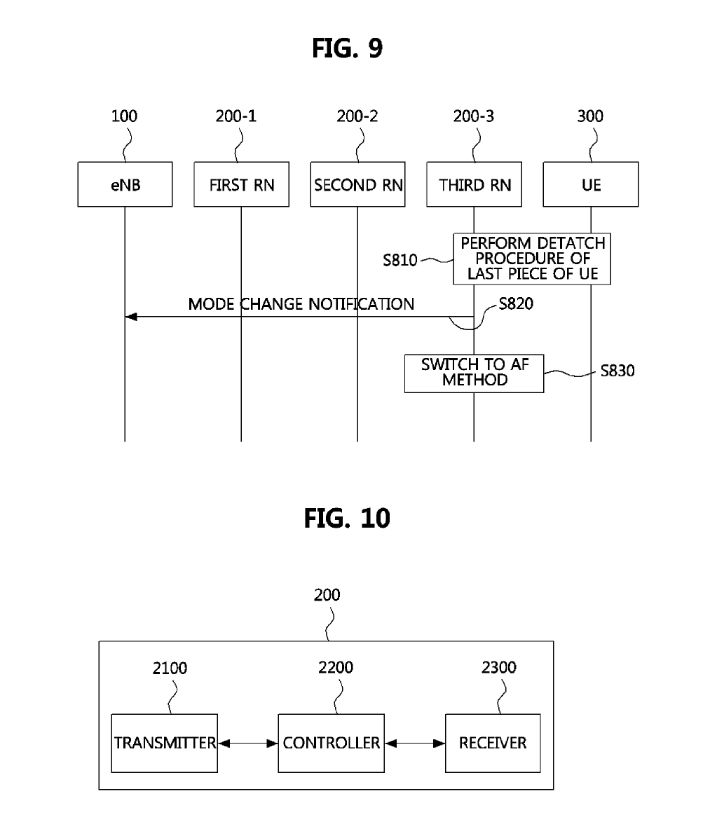

FIG. 9 illustrates still another example embodiment of the mode change operation flow of an RN that operates according to a relaying method of the present invention.

While an RN is operating in the DF method as described above with reference to FIG. 8, all pieces of UE having been attached to the RN may be detached or move to other areas. Like this, when pieces of UE having been attached to an RN disappear, the RN switches back to the AF method to precisely provide a function of a wireless backhaul for other RNs.

Referring to FIG. 9, a last piece of UE 300 attached to a third RN 200-3 performing a cell function performs a detach procedure (S810), the third RN 200-3 notifies an eNB 100 that its operating mode has been changed (S820), and changes the operating mode to the AF method (S830). Although step 820 and step 830 are sequentially illustrated for convenience, the sequence may be reversed, or step 820 and step 830 may be performed at the same time.

FIG. 10 is a block diagram of an RN according to an example embodiment of the present invention.

An RN 200 according to the present invention may include a transmitter 2100, a controller 2200, and a receiver 2300.

The receiver 2300 receives signals transmitted from an eNB and UE, and performs a receiving process on the received signals according to an operating mode of the RN 200.

The transmitter 2100 performs a transmitting process on signals to be transmitted to the eNB and UE according to the operating mode of the RN 200.

The controller 2200 controls the receiver 2300 and the transmitter 2100 to operate in the AF mode of amplifying and forwarding the signals received by the receiver 2300 upon initial setup. Also, the controller 2200 controls the transmitter 2100 to broadcast ID information on the RN 200. When a mode change message is received from the eNB, the controller 220 changes an operating mode to the DF mode, and controls the transmitter 2100 and the receiver 2300 to operate according to the changed operating mode.

Meanwhile, when a last piece of UE having been attached to the RN 200 is detached, the controller 2200 changes the operating mode to the AF mode.

By reusing resources used by the eNB, the controller 2200 performs resource allocation to attached pieces of UE. At this time, it is preferred to reuse as little resources used by the eNB as possible.

As described above, unlike a wireless RN that only provides a single relaying method in an existing mobile communication system, the present invention provides a relaying method in which an RN capable of supporting all multi-relaying methods, such as the AF method and the DF method, is employed.

In the present invention, a relaying method of each RN is not set in advance, but is dynamically switched between the AF method and the DF method according to whether or not UE has been attached to the RN, so that an RN to which no UE has been attached provides a high-speed relay function with minimum delay for other RNs in the AF method.

In addition, the present invention provides a relaying method of, when UE is attached to an RN, switching to the DF method to directly process the attachment of the UE and directly allocate optimum resources for the UE, and reusing resources used by an eNB to improve resource efficiency of a whole cell.

In consideration of merits and demerits of the AF relaying method and the DF relaying method, the present invention described above can improve resource efficiency, which is a merit of the DF relaying method, while having minimum delay time for relay, which is a merit of the AF relaying method.

While the example embodiments of the present invention and their advantages have been described in detail, it should be understood that various changes, substitutions and alterations may be made herein without departing from the scope of the invention.

What is claimed is:

1. A wireless relaying method of a relay node (RN) which relays a signal between an evolved node-B (eNB) and user equipment (UE), the method comprising:
operating in an amplify-and-forward (AF) mode of amplifying and forwarding a received signal upon setup;
broadcasting identifier (ID) information on the RN; and
when a mode change message is received from the eNB, changing an operating mode to a decode-and-forward (DF) mode.

2. The wireless relaying method of claim 1, further comprising, when a random access message is received from at least one piece of UE in the DF mode, generating and transmitting a random access response message to the UE.

3. The wireless relaying method of claim 1, wherein the mode change message includes random access information transmitted from the UE to the eNB.

4. The wireless relaying method of claim 2, wherein the random access message includes an ID of the RN.

5. The wireless relaying method of claim 1, further comprising, when a last piece of UE having been attached to the RN is detached, changing the operating mode of the RN to the AF mode.

6. A method of controlling a mode of a relay node (RN) in an evolved node-B (eNB) which communicates with at least one RN, the method comprising:
receiving a random access signal including an identifier (ID) of the RN from a piece of user equipment (UE);
identifying the RN through the ID of the RN; and
transmitting a mode change request to the identified RN.

7. The method of claim 6, further comprising:
receiving a report that all pieces of UE have been detached from the RN; and
transmitting a mode change notification to the RN.

8. The method of claim 6, wherein the mode change message includes random access information.

9. A wireless relay apparatus which wirelessly relays data between an evolved node-B (eNB) and user equipment (UE), comprising:
a receiver configured to receive signals from the eNB and the UE, and perform a receiving process on the received signals according to an operating mode;
a transmitter configured to perform a transmitting process on signals to be transmitted to the eNB and the UE according to the operating mode; and
a controller configured to operate in an amplify-and-forward (AF) mode of amplifying and forwarding the signals received by the receiver upon setup, to broadcast identifier (ID) information on a relay node (RN), to change the operating mode to a decode-and-forward (DF) mode, and to control the receiver and the transmitter to operate according to the changed operating mode when a mode change message is received from the eNB.

10. The wireless relay apparatus of claim 9, wherein, when a random access message is received from at least one piece of UE in the DF mode, the controller generates and transfers a random access response message to the transmitter.

11. The wireless relay apparatus of claim 9, wherein the mode change message includes random access information transmitted from the UE to the eNB.

12. The wireless relay apparatus of claim 9, wherein, when a last piece of UE having been attached to the RN is detached, the controller changes the operating mode to the AF mode.

13. The wireless relay apparatus of claim 10, wherein the random access message includes an ID of the RN.

14. The wireless relay apparatus of claim 10, wherein the controller performs resource allocation to the at least one attached piece of UE by reusing resources used by the eNB.
